(19) United States
(12) Patent Application Publication
(10) Pub. No.: US 2009/0114520 A1
(43) Pub. Date: May 7, 2009

(54) Method of Producing Charcoal

(75) Inventors: Eiichi Yasuda, Kanagawa (JP); Yasuhiro Tanabe, Kanagawa (JP); Yasunori Nagakura, Kanagawa (JP)

Correspondence Address: KRATZ, QUINTOS & HANSON, LLP, 1420 K Street, N.W., Suite 400, WASHINGTON, DC, 20005, US

(73) Assignee: TOKYO INSTITUTE OF TECHNOLOGY, Tokyo (JP)

(21) Appl. No.: 12/086,006

(22) PCT Filed: Dec. 5, 2006
(86) PCT No.: PCT/JP2006/324295

§ 371 Date: Aug. 14, 2008

(30) Foreign Application Priority Data
Dec. 6, 2005 (JP) 2005-351410

(51) Int. Cl. C10B 57/08; C01B 31/02; B01J 20/20

(52) U.S. Cl. 201/25; 201/36; 201/35

(57) ABSTRACT

A novel method of producing charcoal. The method of producing charcoal comprises treating an organic material with iodine followed by the carbonization treatment. The organic material is desirably an organic material stemming from the biomass. The treatment with iodine is desirably conducted by bringing an iodine vapor into contact with the organic material. Further, the treatment with iodine is desirably conducted by heating a container which contains the organic material and iodine. The temperature in the treatment with iodine is desirably in a range of not lower than 50° C. but not higher than a decomposition temperature of the organic material. Further, the carbonization treatment is desirably a heat treatment conducted in an inert gas atmosphere or in vacuum.

### TECHNICAL FIELD

This invention relates to a novel method of producing new characteristic charcoal.

### BACKGROUND ART

In producing charcoal having a large specific surface area so far, it is a generally accepted practice to once obtain charcoal and, thereafter, flow the steam and carbonic acid gas therethrough for extended periods of time to activate the charcoal. According to some technologies, the step of obtaining charcoal is combined with the step of activation (see, for example, patent documents 1, 2 and 3). According to another technology, the material is mixed with a compound of an alkali metal or a transition metal, and is treated with heat so as to be activated (see, for example, patent document 4).

There has further been known a technology for strikingly improving the shape-retaining property of a pitch by acting iodine upon the pitch that has been widely used as a precursor of a carbon material. Further, a method of producing fibers has been taught in laid-open patent publications (e.g., see patent documents 5 and 6), and application to bulk materials has also been reported (e.g., see non-patent documents 1 and 2).

The present inventor has already disclosed a technical content that is related to the present invention (e.g., see non-patent document 3).
Patent document 1: JP-A-2003-95628
Patent document 2: JP-A-2003-54926
Patent document 3: JP-A-2000-226207
Patent document 4: JP-A-2001-122608
Patent document 5: JP-A-2-80620
Patent document 6: JP-A-1-314734
Non-patent document 1: E. Yasuda et al: TANSO No. 107 (1995) 286-289
Non-patent document 2: H. Kajiura et al: Carbon 35 (1997) 169-174
Non-patent document 3: H. Nagakura et al: Proceeding of the 32^{nd} Annual Meeting of Carbon society of Japan (2005.12.7-9, Ueda Japan) PP. 454-455.

### DISCLOSURE OF THE INVENTION

### Problems to be Solved by the Invention

When the charcoal having a large specific surface area is to be produced as described above, one of the methods is to once obtain charcoal and flow the steam and carbonic acid gas through the charcoal for extended periods of time to activate it. There have further been employed a technology for combining the step of obtaining charcoal with the step of activation, and a technology of mixing a compound of an alkali metal or a transition metal to the material and treating the material with heat to activate it.

However, the former technology of obtaining charcoal and activating it is twice laborious. According to the latter technology which executes the activation and carbonization simultaneously, the specific surface area tends to decrease conspicuously due to the treatment with heat at a high temperature (e.g., 1000° C.) (see Examples of the patent document 2). The method of mixing the compound such as of an alkali metal leaves a problem of removing the compound or the carbide thereof. Neither of these methods is capable of obtaining charcoal having a high specific surface area at a large ratio (yield) from the starting material. Besides, stable charcoal treated with heat at high temperatures is not allowed to possess a high specific surface area.

As described above, further, a method has been known to strikingly improve the shape-retaining property of pitch by acting iodine on the pitch that is widely used as a precursor of the carbon material, while a method of producing fibers has been taught in the laid-open patent publication, and the application to bulk materials has also been reported.

The treatment with iodine makes it possible to strikingly improve the yield of carbon using the pitch as a precursor and can, further, be applied to large materials, too, imparting shape-retaining property. Besides, iodine migrates out of the sample through the step carbonization at 1000° C. and no after-treatment is necessary. The study has been conducted concerning the strength and the modulus of elasticity by the treatment with iodine (see patent documents 5 and 6), but quite no study has been forwarded concerning the specific surface area, shape of pores and distribution of pores.

The present invention was accomplished in view of the above problems and has an object of providing a novel method of producing new characteristic charcoal.

### Means for Solving the Problems

To achieve the object of the present invention by solving the above problems, a method of producing charcoal of the invention comprises treating an organic material with iodine followed by the carbonization treatment to produce characteristic charcoal.

Here, though not limited thereto only, it is desired that the organic material is an organic material stemming from the biomass. Further, though not limited thereto only, it is desired that the organic material stemming from the biomass comprises one or a plurality of those selected from lignin, cellulose, amylose, rubber, sugar and hemicellulose. Further, though not limited thereto only, it is desired that the treatment with iodine is a treatment of bringing an iodine vapor into contact with the organic material. Further, though not limited thereto only, it is desired that the treatment with iodine comprises heating a container which contains the organic material and iodine. Further, though not limited thereto only, it is desired that the temperature in the treatment with iodine is in a range of not lower than 50° C. but not higher than a decomposition temperature of the organic material. Further, though not limited thereto only, it is desired that the carbonization treatment is a heat treatment conducted in an inert gas atmosphere or in vacuum. Further, though not limited thereto only, it is desired that the inert gas comprises one or a plurality of those selected from helium, argon, xenon and nitrogen. Further, though not limited thereto only, it is desired that the temperature in the carbonization treatment is in a range of 400 to 3000° C.

### EFFECT OF THE INVENTION

The invention exhibits the effect as described below.

Namely, the invention provides a novel method of producing charcoal by treating an organic material with iodine followed by the carbonization treatment.

### BRIEF DESCRIPTION OF THE DRAWINGS

FIG. 1 is a diagram illustrating changes in the nitrogen adsorption amount depending upon the treatment with iodine.

### BEST MODE FOR CARRYING OUT THE INVENTION

Described below is the best mode for carrying out the invention which is related to a method of producing charcoal.

The method of producing charcoal of the present invention comprises treating an organic material with iodine followed by the carbonization treatment.

Here, the organic material is an organic material stemming from the biomass as lignin, cellulose, amylose, rubber, sugar, hemicellulose and so on.

There is no particular limitation on the shape of the organic material stemming from the biomass, and any shape can be employed.

Though there is no particular limitation on the size of the organic material stemming from the biomass, it is desired that the following conditions are satisfied. Namely, for every point present in the organic material stemming from the biomass, it is desired that a straight distance between the point and the outer surface closest to the point is not larger than 50 mm. When the straight distance is not larger than 50 mm between the point in the organic material stemming from the biomass and the outer surface closest to the point, it is made possible to prevent the formation of treating spots and to produce the product of homogeneous quality.

In the foregoing was described the organic material stemming from the biomass as an object to which the invention can be applied. However, the object to which the invention can be applied is not limited to the organic material stemming from the biomass only. There can be further used, for example, pitch, polyacetylene, anthracene, perillene, diphenanthroperillene, dibenzonaphthopyranthrene or dibenzoisoviolanthrene.

The treatment with iodine is a treatment of bringing an iodine vapor into contact with the organic material. Concretely, the treatment with iodine comprises heating a container which contains the organic material and iodine.

It is desired to deaerate the container containing the organic material and iodine prior to conducting the treatment with iodine. Deaeration suppresses the side-reaction and enhances the efficiency of treatment with iodine. Here, the container does not necessarily have to be deaerated prior to conducting the treatment with iodine.

In the treatment with iodine, the container containing the organic material and iodine is heated and whereby iodine sublimates to generate an iodine vapor. Therefore, the iodine vapor can be contacted with the organic material. There is no particular limitation on the pressure of the iodine vapor or on the concentration of the iodine vapor.

As the method of heating the container in the treatment with iodine, a heating method based on an oil bath can be employed. The heating method, however, is not limited to the heating method based on the oil bath only but any other heating method may be employed.

It is desired that the temperature in the treatment with iodine is in a range of not lower than 50° C. but not higher than a decomposition temperature of the organic material. It is further desired that the temperature is in a range of not lower than 60° C. but not higher than 200° C.

If the temperature is not lower than 50° C., an advantage is obtained in that the sample as a whole can be treated while suppressing the formation of spots of treatment. The effect becomes more conspicuous if the temperature is not lower than 60° C.

If the temperature is not higher than the decomposition temperature of the organic material, an advantage is obtained in that the sample exhibits a high shape-retaining property at the time of treatment and is suppressed from being degenerated. The effect becomes more conspicuous if the temperature is not higher than 200° C.

In the foregoing was described bringing the iodine vapor into contact with the organic material. What is brought into contact with the organic material is not limited to the iodine vapor only. There can be further employed an aqueous solution thereof or a solid thereof.

The carbonization treatment is a treatment for heating the organic material in an inert gas atmosphere or in vacuum.

As the inert gas, there can be used one or a plurality of those selected from helium, argon, xenon and nitrogen.

It is desired that the temperature in the carbonization treatment is in a range of 400 to 3000° C. If the temperature is not lower than 400° C., iodine in the sample mostly migrates out of the sample during the carbonization treatment, offering an advantage in that no after-treatment is required for removing iodine from the sample. If the temperature is not higher than 3000° C., an advantage of good efficiency is obtained permitting the amount of carbon to be little decreased by sublimation.

The carbonization treatment may be followed by the activation treatment. Upon executing the activation treatment after the carbonization treatment, pores can be introduced having diameters or shapes different from those of the pores formed by the treatment with iodine, and the function can be further increased as the adsorbing agent or the separating agent.

Upon treating the organic material stemming from the biomass with iodine (upon bringing the iodine vapor into contact with the organic material stemming from the biomass at a relatively low temperature) to turn it into charcoal, it is allowed it makes possible to produce in a high char yield having finely controlled pore diameter and a high specific surface area through the heat treatment at 1000° C.

With the ordinary heat treatment, it is difficult to control the shape due to the cracking reaction resulting in a decrease in the yield after the carbonization and in the amount of fine pores. By conducting the treatment with iodine, however, the yield of carbon increases and the shape can be controlled presumably contributing to increasing the specific surface area and increasing the gas adsorption amount.

The charcoal produced according to the present invention can be used as a carbon dioxide gas-adsorbing agent, an agent for separating oxygen and nitrogen, a capacitor and the like.

According to the best mode for carrying out the invention as described above, there is provided a novel method of producing charcoal by treating an organic material with iodine followed by the carbonization treatment.

It should be noted that the present invention is not limited to the above best mode for carrying out the invention, but can be constituted in various other ways without departing from the gist of the invention, as a matter of course.

### EXAMPLE

Next, the invention will be concretely described by way of Example to which only, however, the invention is in no way limited.

First, described below is how to prepare a sample.

### Example

Lignin, cellulose and amylose (each in an amount of about 1 g) were introduced together with 10 g of an iodine powder into a flask, were deaerated in vacuum (300 Pa or lower), and were brought into contact with the saturated vapor of iodine in an oil bath of 60° C. for 24 hours so as to be treated with iodine. The samples after the treatment with iodine were taken out, heated up to 1000° C. in an inert atmosphere (argon gas) and were held therein for 30 minutes. Thereafter, the samples were cooled down to room temperature in the inert atmosphere. The carbonization treatment was thus conducted.

### Comparative Example

As Comparative Example, the treatment with iodine was omitted from the operation of the above Example. That is, the lignin, cellulose and amylose were heated up to 1000° C. in an inert atmosphere and were held therein for 30 minutes. Thereafter, the samples were cooled down to room temperature in the inert atmosphere.

The samples prepared above were evaluated. Described below are the evaluation methods.

The yield of carbon was calculated by dividing the weight thereof after the heat treatment by the weight thereof before the heat treatment.

The adsorption was measured relying on the capacity method at the liquid nitrogen temperature (77K) for the samples of a weight of 500 mg.

The obtained isothermal lines were α s-plotted [Academy of Carbon Materials, “Latest Technology for Experimenting Carbon Materials (Evaluation of Properties/Materials)”, Cypec Co., pp. 1-7 (2003); P. J. M. Carrott, R. A. Robers, K. S. W. Sing, “Adsorption of Nitrogen by Porous and Non-Porous Carbons”, Carbon, 25, (1987) 59-68] to calculate the specific surface areas.

Described below are the evaluated results of the thus prepared samples.

Yields of Carbon.

Table 1 shows the yields of carbon after the carbonization treatment. The lignin shows an increase by 27% while the cellulose and amylose show an increase of 4% as compared to those of not treated. This is an increase by 60% to 2 times if considered on the basis of residual carbon of when not treated. An increase in the yields of carbon improves the yields of products.

[Table 1]

TABLE 1
Yields of carbon.

| | Untreated | Treated with Iodine |
|---|---|---|
| Lignin | 40.9% | 67.9% |
| Cellulose | 6.1% | 10.4% |
| Amylose | 3.8% | 7.7% |

Specific Surface Area.

Table 2 shows specific surface areas of the carbonation-treated samples calculated from the nitrogen adsorption isothermal lines relying on the α s-plotting method. The lignin shows an increase of not less than 200 times, the cellulose shows an increase of 2 times and the amylose shows an increase of 20%. An increase in the surface area enables the samples to exhibit increased functions as adsorbing agents or separating agents being used in less amounts.

[Table 2]

TABLE 2
Specific surface areas (αs-plotted).

| | Untreated | | Treated with Iodine |
|---|---|---|---|
| Lignin | 5 | m²/g | 1080 m²/g |
| Cellulose | 685 | m²/g | 1382 m²/g |
| Amylose | 912 | m²/g | 1143 m²/g |

Relationship between the nitrogen gas adsorption amount and the relative pressure of nitrogen.

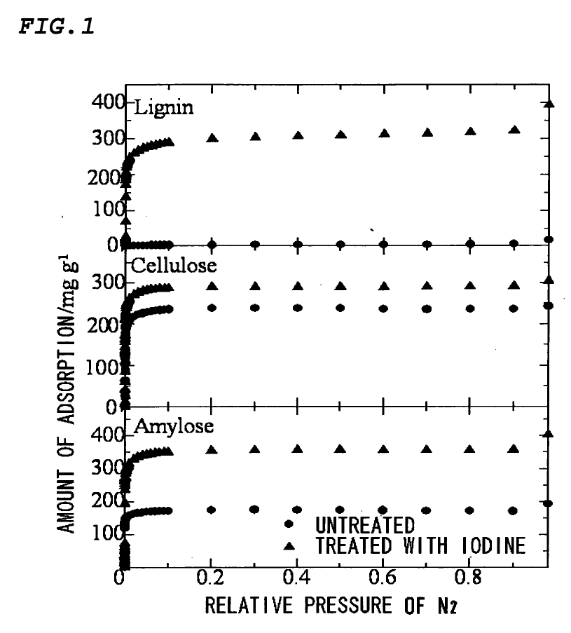

FIG. 1 shows a relationship between the nitrogen gas adsorption amount and the relative pressure of nitrogen of the lignin char, cellulose char and amylose char. All samples show an increase in the amounts of adsorption as a result of the treatment with iodine. In particular, the lignin shows an increase in the adsorption amount by several tens of times. It is, therefore, expected that a high adsorption performance or separation performance can be obtained by the use in small amounts.

According to Example of this invention as described above, not only the yield of carbon but also the specific surface area can be increased by treating the organic material stemming from the biomass with iodine followed by the carbonization. This means that the active charcoal can be obtained from the organic material stemming from the biomass without effecting the activation treatment or effecting the activation treatment to only a decreased degree.

1. A method of producing charcoal comprising treating an organic material with iodine followed by the carbonization treatment.

2. The method of producing charcoal according to claim 1, wherein the organic material is an organic material stemming from the biomass.

3. The method of producing charcoal according to claim 2, wherein the organic material stemming from the biomass comprises one or a plurality of those selected from lignin, cellulose, amylose, rubber, sugar and hemicellulose.

4. The method of producing charcoal according to claim 1, wherein the treatment with iodine is a treatment of bringing an iodine vapor into contact with the organic material.

5. The method of producing charcoal according to claim 4, wherein the treatment with iodine comprises heating a container which contains the organic material and iodine.

6. The method of producing charcoal according to claim 4, wherein the temperature in the treatment with iodine is in a range of not lower than 50° C. but not higher than a decomposition temperature of the organic material.

7. The method of producing charcoal according to claim 1, wherein the carbonization treatment is a heat treatment conducted in an inert gas atmosphere or in vacuum.

8. The method of producing charcoal according to claim 7, wherein the inert gas comprises one or a plurality of those selected from helium, argon, xenon and nitrogen.

9. The method of producing charcoal according to claim 7, wherein the temperature in the carbonization treatment is in a range of 400 to 3000° C.
